(19) United States
(12) Patent Application Publication
(10) Pub. No.: US 2006/0072897 A1
(43) Pub. Date: Apr. 6, 2006

(54) Method and device to manage the recording of an audio/video stream within a communications network, and corresponding computer program product

(75) Inventors: Tristan Halna Du Fretay, Rennes (FR); Stephane Bizet, Liffre (FR); Lionel Tocze, Saint Domineuc (FR)

Correspondence Address: FITZPATRICK CELLA HARPER & SCINTO, 30 ROCKEFELLER PLAZA, NEW YORK, NY, 10112, US

(73) Assignee: CANON EUROPA N.V.

(21) Appl. No.: 11/242,050

(22) Filed: Oct. 4, 2005

(30) Foreign Application Priority Data
Oct. 6, 2004 (FR) 04-10551

(51) Int. Cl. H04N 5/781

(52) U.S. Cl. 386/46; 386/125

(57) ABSTRACT

A method for the management of the recording of an audio/video stream within a communications network comprises a step for setting up a first recording connection between a source device and a recording device connected to said communications network. The step for setting up the first recording connection is followed by a step for setting up a second viewing connection between the recording device and a display device also connected to the network, so that a user can observe an audio/video image corresponding to the audio/video stream, on said display device, while the stream is being recorded by the recording device.

### FIELD OF THE INVENTION

The field of the invention is that of communications nets or networks enabling the interconnection of a plurality of devices (hereinafter also called apparatuses) and especially, but not exclusively, home audiovisual networks used to interconnect analog and/or digital type audio and/or video devices so that they may exchange audiovisual signals.

The above-mentioned apparatuses belong for example to the following list which is not exhaustive: television receivers (using satellite, RF channels, cable, xDSL and other means), video-cassette recorders, scanners, digital video cameras, digital cameras, DVD readers, computers, personal digital assistants (PDAs), printers, etc.

The network comprises, for example, a backbone network, for example a switched network or one or more digital buses of the IEEE 1394 type to which a plurality of sub-networks (for example digital buses of the IEEE 1394 type) are connected through devices called “nodes”. The apparatuses are connected to the sub-networks, by direct connection in the case of the digital devices or by connection through an analog/digital converter in the case of the analog devices.

It may be recalled that the IEEE 1394 standard is described in the following reference documents: “IEEE Std 1394-1995, Standard for High Performance Serial Bus” and “IEEE Std 1394a-2000, Standard for High Performance Serial Bus (Supplement)”. The interconnection of digital buses by bridges is furthermore defined in the “IEEE P1394.1 Draft Standard for High Performance Serial Bus Bridges (Draft 1.04 Oct. 24, 2002)”.

More specifically, the invention relates to a method to manage the recording of an audio/video stream within a communications net or network.

This classically implies the setting up of a recording connection between a source device that generates an audio/video stream (for example a digital video camera, a digital photographic camera, a DVD reader etc.) and a device for the recording of this audio/video stream (for example a video-cassette recorder).

### PRIOR ART APPROACHES

According to a known technique, each node of the network co-operates with a television set (or more generally a display device) that is connected and associated with it. Together they offer a user interface by which the user, generally using a remote control unit or “remote”, sends out infrared commands intended for the node, can:
select a source device and a recording device (for example of video-cassette recorder);
request the establishment of a recording connection between this source device and this recording device; and
launch the recording operation using the recording device.

The above-mentioned prior art technique is not optimal because, in general, a user launching the recording of a given stream, cannot use it to ascertain that the recording device is effectively recording this given stream.

Indeed, the only way at present for a user to perform such verification is to directly connect a display device (a television set) to the recording device (video-cassette recorder).

Now, the user is generally not in the same room as the recording device that he wishes to use. He therefore cannot view the stream being recorded by the video-cassette recorder on the television set directly connected to the video-cassette recorder. Indeed, it often happens that the user interacts with a first node of the network (the one before him in the room in which he is located), while the source device is connected to a second node (which is in another room) and the recording device in a third node (which is in yet another room).

### GOALS OF THE INVENTION

It is a goal of the invention especially to overcome these different drawbacks of the prior art.

More specifically, it is one of the goals of the present invention to provide a method for the management of the recording of an audio/video stream within a communications network, this method enabling the user to ascertain that the recording device is recording the right given stream, regardless of the position of the user in the place (for example a house or a building) in which the communications network is installed.

It is also a goal of the invention to provide a method of this kind that is simple to implement and costs little.

It is another goal of the invention to provide a method of this kind which, in a particular embodiment, enables the user to take action easily on the source device and/or the recording device during recording, especially if a problem is detected (for example a wrong stream recording or even no stream recording).

It is a complementary goal of the invention to provide a method of this kind which, in a particular embodiment, requires few or no additional actions, as compared with those performed when the above-mentioned prior art technique is implemented.

### ESSENTIAL CHARACTERISTICS OF THE INVENTION

These different goals as well as others that shall appear here below, are achieved according to the invention by means of a method for the management of the recording of an audio/video stream within a communications network, said method comprising a step for setting up a first recording connection between a source device and a recording device connected to said communications network. According to the invention, said step for setting up the first recording connection is followed by a step for setting up a second viewing connection between the recording device and a display device also connected to said network, so that a user can observe an audio/video image corresponding to the audio/video stream, on said display device, while the stream is being recorded by the recording device.

The general principle of the invention therefore consists in enabling the user to view the stream output from the recording device (which is the effectively recorded stream), and not the stream output from the source device (which is the stream supposed to be recorded). Thus, and since if everything happens as it should these two streams are identical, the user can be sure that it is the right stream that has been recorded.

Advantageously, the execution at the user's request of said step for setting up the first recording connection leads to the automatic execution, by the network, of said step for setting up the second viewing connection.

In other words, to view the stream recorded by the recording device, the user performs no action complementary to the usual ones (the launching of a recording procedure and the selection of source and recording devices).

In a particular embodiment of the invention, the communications network comprises a backbone network itself comprising a plurality of nodes to which a plurality of devices and especially said source device, said recording device and said display device are connected, directly or via sub-networks. Said method is implemented in said nodes.

Advantageously, said display device is selected by default, as a display device associated and connected with the node with which said user interacts, through a user interface, to request the execution of said step for setting up the first recording connection.

According to an advantageous characteristic, the step for setting up the first recording connection is preceded by the following successive steps:
the selection of the source device, by default or by the user, through a user interface;
the setting up of a preliminary viewing connection between the source device and the display device;
the sending by the user, through said user interface, of a recording request;
the selection of the recording device, by default or by the user, using said user interface;
the elimination of said preliminary display device.

Advantageously, the step for setting up the first recording connection is preceded by a step for the storage of an address of the source device. Furthermore, the step for setting up the second viewing connection between the recording device and the display device is followed by a step for the management of the user interface comprising a first control panel (or screen) displayed on the display device and enabling the user to control the source device by the sending of commands, via the communications network, to the previously stored address of the source device.

Advantageously, the step for setting up the first recording connection is preceded by a step for the storage of an address of the recording device, and the step for setting up the second display connection, between the recording device and the display device, is followed by a step for the management of a user interface comprising a second control panel displayed on the display device and enabling the user to control the recording device by the sending of commands, through the communications network, to the previously stored address of the recording device.

Advantageously, the second control panel enables the user to request the sending of a recording command to the recording device.

In an advantageous variant, the step for setting up the first recording connection is followed by a step for the automatic sending of a recording command to the recording device, so that the recording device starts recording immediately upon reception of said recording command. Furthermore, the step for setting up the second viewing connection is preceded by said step for sending a recording command.

Preferably, the communications network comprises a backbone network itself comprising a plurality of nodes to which a plurality of devices, and especially said source device, said recording device and said display device are connected, directly or via sub-networks. The method of the invention furthermore comprises a step for locking the recording device so that it executes only commands sent by the node with which the user interacts, via a user interface, to request the execution of said step for setting up the first recording connection.

Advantageously, the method of the invention furthermore comprises the following steps:
the sending of a request to stop said recording; and
the elimination of said first recording connection, between the source device and the recording device.

In a first particular embodiment of the invention, after the elimination of said first recording connection, said second viewing connection, between the recording device and the display device is kept.

In a second particular embodiment of the invention, after the elimination of said first recording connection, said second viewing connection, between the recording device and the display device, is replaced by a connection between the source device and the display device.

Advantageously, the step for eliminating the first recording connection is followed by a step for unlocking the recording device.

The invention also relates to a computer program product, comprising program code instructions for the execution of the steps of the method according to the invention, when said program is executed on a computer.

The invention also relates to a device to manage the recording of an audio/video stream within a communications network, said device comprising means for setting up a first recording connection between a source device and a recording device connected to said communications network. According to the invention, said device furthermore comprises means for setting up a second viewing connection between the recording device and a display device also connected to said network, so that a user can observe an audio/video image corresponding to the audio/video stream, on said display device, while the stream is being recorded by the recording device.

This device may or may not be integrated with the node of the network.

Advantageously, said device furthermore comprises the following means, activated before said means for setting up the first recording connection:
means for the selection of the source device, by default or by the user through a user interface;
means for setting up a preliminary viewing connection between the source device and the display device;
means for the reception of a recording request sent by the user, by means of said user interface;
means for the selection of the recording device, by default or by the user through said user interface;
means for the elimination of said preliminary viewing connection.

In a first particular embodiment of the invention, said device furthermore comprises:
means to receive a request to stop said recording;
means to receive said first recording connection, between the source device and the recording device;
means to maintain said second viewing connection, between the recording device and the display device, after the elimination of said first recording connection.

In a second particular embodiment of the invention, said device furthermore comprises:
means to receive a request to stop said recording;
means to eliminate said first recording connection, between the source device and the recording device;
means to replace said second viewing connection, between the recording device and the display device, by a connection between the source device and the display device, after the elimination of said first recording connection.

### LIST OF FIGURES

Other features and advantages of the invention should appear from the following description of a preferred embodiment of the invention, given by way of an example that is indicatory and not exhaustive, and from the appended drawings of which:

FIG. 1 shows a home network in which it is possible to implement the method according to the invention for managing the recording of an audio/video stream;

FIG. 2 is a block diagram of an audio/video interface module included in the multimedia interface device (node) shown in FIG. 1;

FIG. 3 shows a hardware architecture of an analog/digital converter belonging to the network of FIG. 1;

FIG. 4 shows a particular embodiment of a panel of connectors located on the rear face of a node (multimedia interface device) shown in FIG. 1;

FIG. 5 is a flow chart of a first particular embodiment of the method according to the invention;

FIG. 6 is a flow chart of a second particular embodiment of the method according to the invention;

FIG. 7a is a flow chart of an algorithm according to the invention for the addition/elimination of an analog device by way of a recording device connected to the network;

FIG. 7b is a flow chart of an algorithm according to the invention for the definition of a recording device associated by default to the network;

FIG. 7c is a flow chart of an algorithm according to the invention for the processing, by each node, of a message for the updating of a list of recording devices connected to the network;

FIG. 8 is a flow chart of an algorithm according to the invention for the management of a list of recording devices connected to the network, after a digital device has been connected to or disconnected from the network;

FIG. 9 is a flow chart of an algorithm according to the invention for stopping a recording session;

FIG. 10a is a flow chart of an algorithm according to the invention for processing a message for the locking of a recording device; and

FIG. 10b is a flow chart of an algorithm according to the invention for processing a message containing a command for the control of a recording device, this message being sent during one of the steps of the method shown in FIG. 5.

### DESCRIPTION OF AN EMBODIMENT OF THE INVENTION

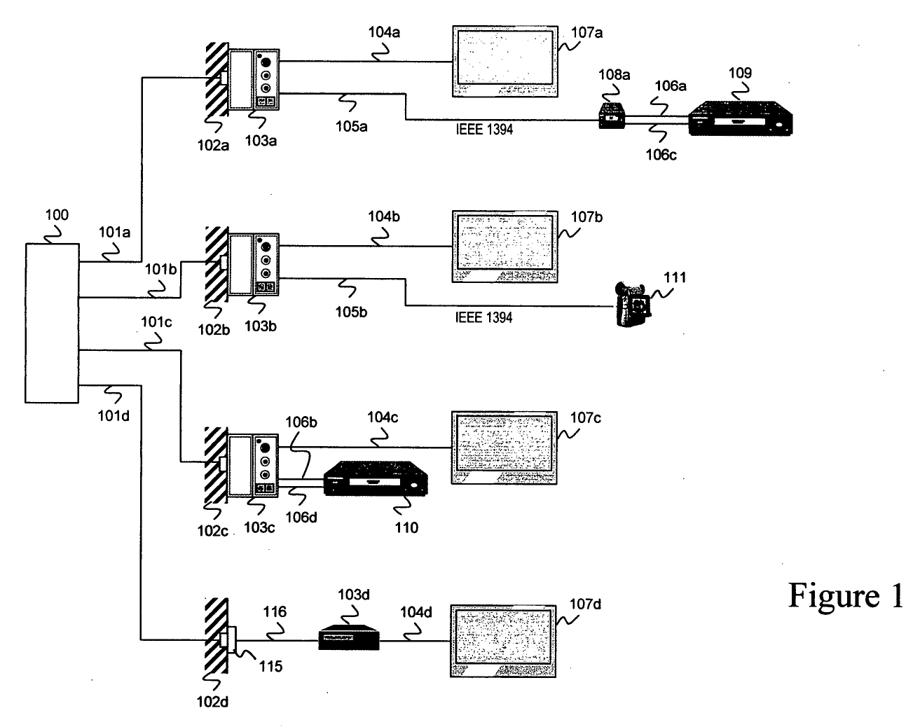

FIG. 1 shows a multimedia communications network in which the method of the invention to manage the recording of an audio/video stream can be implemented. This network is installed for example in a home environment.

The network interconnects devices such as television sets referenced 107a, 107b, 107c and 107d and video-cassette recorders referenced 109 and 110, as well as a digital camcorder referenced 111.

This network has multimedia interface devices referenced 103a, 103b, 103c and 103d (also called nodes hereinafter in the description). The multimedia interface devices referenced 103a, 103b, 103c are for example built into the partition walls 102a, 102b and 102c of the rooms of the dwelling. The multimedia interface device referenced 130d is not built into the partition wall but is connected through a link 116 to the connector referenced 115. These multimedia interface devices are connected to a central switching unit 100 preferably placed beside the electrical power supply panel through links referenced 101a, 101b, 101c, 101d and 116. These links are, for example, of the UTP5 (“Unshielded Twisted Pair, category 5) type as specified in the ANSI/TIA/EIA/568A standard) classically used in Ethernet type networks, and the connector referenced 115 is of the RJ45 type. It must be noted that other types of links could be used, such as optic fiber links or IEEE 1355 compliant cables.

Each of the multimedia interface devices comprises at least connection means of the Ethernet or IEEE1394 type and an analog video output. All the information obtained by the connection means will be distributed to other remote multimedia interface devices through the central switching unit and links connecting this unit to the different multimedia interface devices.

Thus the multimedia interface devices referenced 103a, 103b, 103c and 103d and the central switching unit 100 together form a backbone network, sometimes also called a “home network backbone”.

The television set 107a is connected by means of an analog video link 104a to the multimedia interface device 103a. According to one variant, the link 104a may be compliant with the IEEE 1394 standard and the television set then has an IEEE 1394 board. Similarly the television sets 107b, 107c and 107d are respectively connected to the multimedia interface devices 130b, 103c and 103d by means of analog video links 104b, 104c and 104d.

The analog video-cassette recorder referenced 109 is connected by means of a pair of analog links 106a and 106c (one for the video input in the other for the video output) to an analog/digital converter referenced 108a. This converter is itself connected by means of a IEEE 1394 compliant digital link 105a to the multimedia interface device 103a. This converter converts the analog video information generated by the analog video-cassette recorder 109 into an IEEE 1394 compliant standard.

The analog video-cassette recorder referenced 110 is directly connected by a pair of analog links 106b and 106d (one for the video input and the other for the video output), to the multimedia interface device 103c.

Each source device (a digital camcorder referenced 111, in this example) is accessible from any room, through one of the display devices (television sets 107a, 107b, 107c or 107d, in this example).

Conventionally, through a remote control unit placed at his disposal, the user sends infrared commands to one of the multimedia interface devices 103a, 103b, 103c or 103d. These commands are interpreted to set up connections between the source devices and the display devices, or connections between the source devices and the recording devices.

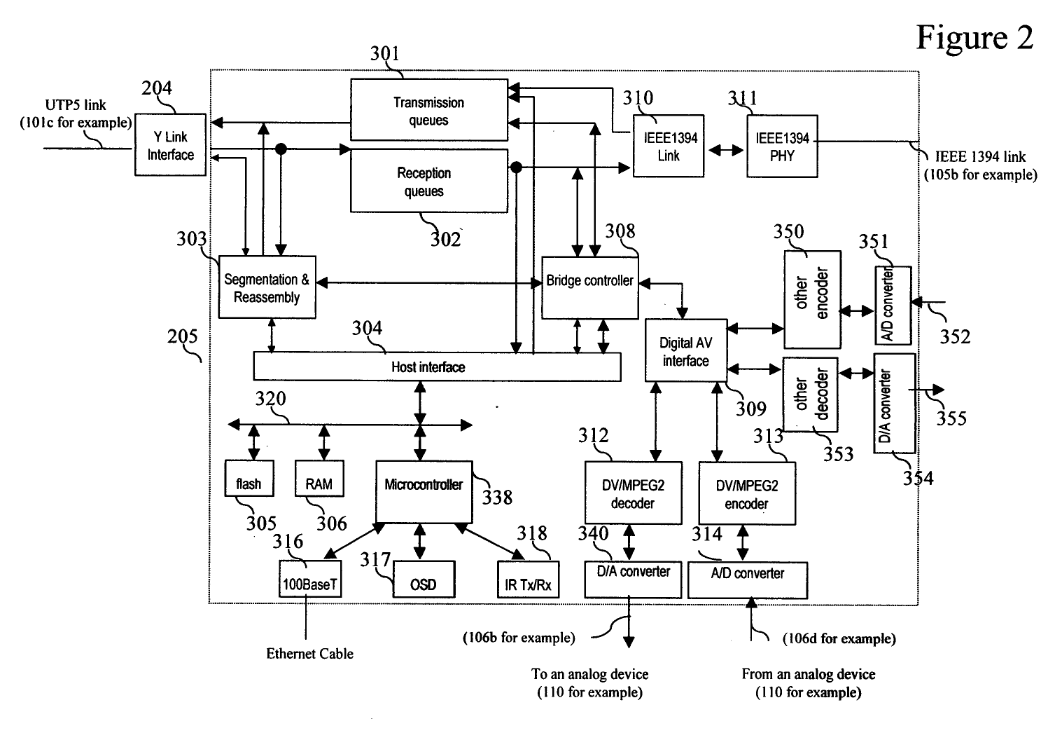

FIG. 2 is a block diagram of an audio/video interface module 205 included in a multimedia interface device (node) referenced 103x, with x=a, b, c or d, in FIG. 1.

In general, an audio/video interface module 205 possesses a plurality of connection means by which signals of different kinds will be processed. The data coming from these connection means will be mixed together so as to form only one data stream compliant with a given protocol that is forwarded by means of the Y-Link interface 204 on the single medium which, in the example of FIG. 1, is a UTP5 type link referenced 101x, with x=a, b, c or d.

This audio/video interface 205 will also manage the quality of service constraints associated with these different signals.

The audio/video interface comprises a microcontroller 338 that will transfer data on the bus 320 to RAM (Random Access Memory) type storage means 306, more particularly when the data comes for example from the link 101x.

When the multimedia interface device is powered on, the microcontroller 338 will load the program contained in the flash memory 305 into the RAM 306 and execute the code associated with this program.

The microcontroller 338 will transfer information coming from the different connection means to a transmission queue referenced 301. This transfer complies with the quality of service required for the transfer of this information. Indeed, IEEE 1394 type networks enable the exchange of isochronous or asynchronous type data. The isochronous type data is governed by transmission bit rate imperatives while asynchronous type data can be transmitted without transmission bit rate imperatives. The transfer of data according to a quality of service is described in the European patent application No. 01400316. It shall not be described in fuller detail.

The microcontroller 338 has a 100baseT type Ethernet interface 316 connected to it, enabling the connection of an Ethernet cable.

A character generator or “on-screen display” unit 317 is also connected to the microcontroller 338. This character generator 317 will enable the insertion of information into the video signal transmitted for example on the IEEE 1394 link referenced 105b in FIG. 1.

An infrared transmission and reception module 318 is also connected to the microcontroller 338. Through this infrared module 318, infrared command signals coming from a remote control unit will be received and then retransmitted by means of the microcontroller 338 to the different devices connected to the network. This transfer of infrared commands is described in the French patent application number FR 0110367. It must be noted that, in one variant, the infrared module is preferably a one-way module.

Through the bus interface 304, the microcontroller 338 will also manage the configuration of the transmission parameters associated with each transmission queue, these parameters being stored in the segmentation and re-assembly module 303.

For the transmission queues associated with an isochronous type data stream (these queues are known as “stream mode buffers”), the segmentation and re-assembly module 303 guarantees the minimum transmission bit rate necessary for the isochronous type data stream on the basis of the transmission parameters.

For the transmission queues associated with an asynchronous type data stream (these queues are known as “message mode buffers”), the segmentation and re-assembly module 303 ensures a maximum bit rate for the asynchronous type data stream on the basis of the transmission parameters.

The transmission parameters associated with each transmission buffer are computed by the microcontroller 338:
as a function of a reservation of bandwidth in the network for “stream mode buffer” type queues;
locally as a function of an estimation of the bandwidth available in the network for “message mode buffer” type queues.

The transfer of data according to these two modes of transmission is described in the European patent application number 01400316 and shall not be described more fully.

This data comes:
either from the devices connected to the IEEE 1394 type links such for example the link 105b,
or from an analog device (such as for example the video-cassette recorder referenced 110 in FIG. 1) connected to the analog/digital converter 314 (by a link 106d in the above-mention example),
or from a micro-computer type device connected to the Ethernet interface 316.

Should the analog data come, for example, from a video-cassette recorder 112 directly connected to the multimedia interface, this data will be converted by the analog/digital converter 314 and then encoded in an MPEG2 or DV type format by the module 313. This encoded data will then be forwarded by means of the digital audio/video interface 309 and the bridge controller 308 to the transmission queue 301. DV is a shortened form of the SD-DVCR (“Standard Definition Digital Video-Cassette Recorder”) format. MPEG2 is the acronym for “Motion Picture Expert Group 2”. It must be noted that the analog/digital converter 108b shown in FIG. 1 is herein integrated into the multimedia interface device 103c.

For data other than MPEG2 or DV type data (for example in a proprietary format), another encoder 350 and another analog/digital converter 351 are planned. Their role is directly deduced from the elements referenced 353 and 355 described here above.

Should the data come from a device connected to an IEEE 1394 link such as, for example, the link 105a, two types of processing will be performed depending on the nature of the data. If this data is asynchronous type data, it will travel through the bus interface 304 and be stored in the memory 306. The microcontroller 338 transfers this data to a transmission queue 301 (of the “message mode buffer” type). If it is isochronous type data, the data will travel directly to a “stream mode buffer” type of transmission queue 301.

The microcontroller 338 will also use the bus interface 304 to manage the distribution of the data received by means of the Y link interface 204 and stored in the reception queue 302.

For isochronous type data, and depending on the destination of this data, the microcontroller 338 will activate the transfer of the data either towards the controller of the IEEE 1394 link referenced 310, if this data is intended for at least one of the terminals connected to the bus 105b for example, or towards the bridge controller 308, if the data is intended for an analog device connected to the link 106b for example.

For asynchronous type data, the microcontroller 338 will activate the transfer of the data to the RAM 306 through the bus interface 304. The Ethernet type asynchronous data will then be sent to the interface 316.

The IEEE 1394 type asynchronous data will then be sent to the interface referenced 311.

If the data is intended for an analog device connected to the link 106b for example, the microcontroller 338 will activate the transfer of this data to the digital audio/video interface 309 by means of the bridge controller 308. This MPEG2 or DV type data will then be decoded by the decoder 312 and finally forwarded to the digital/analog converter 340, which enables the transfer of the information in analog form, for example, to the analog device (the video-cassette recorder 110 in this example) connected to the digital/analog converter 340 by the link 106b.

For data other than MPEG2 or DV type data (for example in a proprietary format), another decoder 353 and another digital/analog converter 354 are planned. Their role is directly deduced from the elements referenced 312 and 340 described here above.

The segmentation and re-assembly module 303 controls the sending of the data in packet form from the transmission queues to the Y link interface 204. Each packet has a routing header as well as a packet type header (of the “message” or “stream” type depending on the transmission queue). The information on routing and type of packet is configured by the microcontroller 338.

Furthermore, the segmentation and re-assembly module 303 controls the reception of the packets from the Y link interface 204 in order to store the data as a function of the type of packet in the appropriate reception queue, which is either of the “message mode buffer” type or of the “stream mode buffer” type.

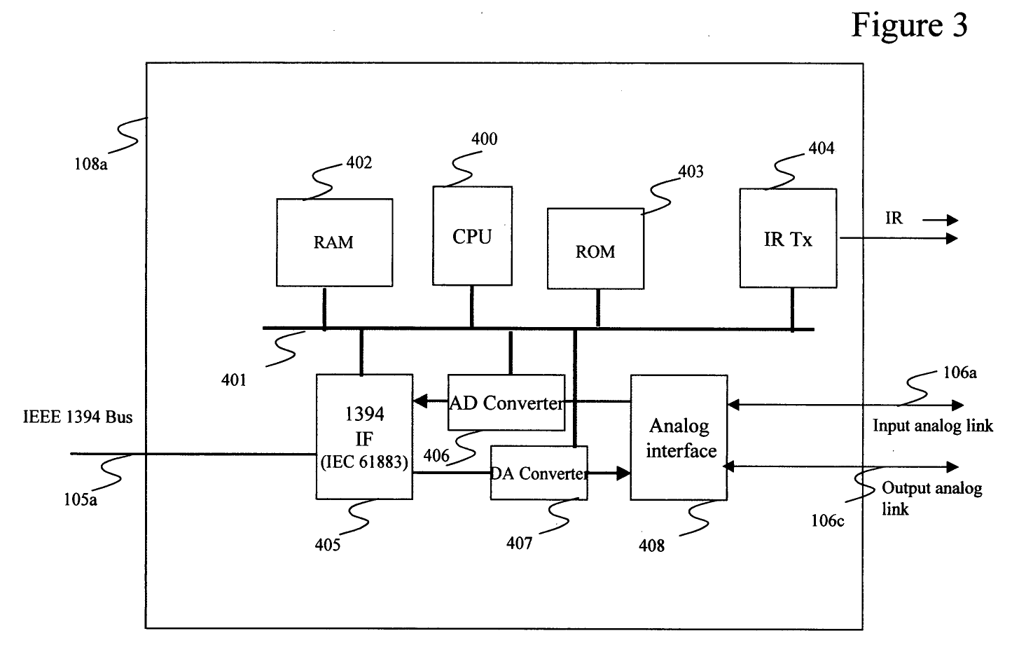

FIG. 3 is a diagrammatic illustration of the hardware architecture of the analog/digital converter referenced 108a in FIG. 1.

The converter 108a comprises the following elements connected to one another by an address and data bus 401:
a processor 400;
a flash type random-access memory (or battery-saved memory) 402 enabling the keeping of the data including after a period when the converter 108a has not been powered;
a non-volatile memory 403;
a module 403 for sending IR signals;
an IEEE 1394 input/output interface 405 enabling the connection of the bus 105a;
an analog interface 408 enabling the connection of an input analog link 106a (video input) and an output analog link 106c (video output);
an analog/digital conversion module 406 between the interfaces 408 and 405; and
a digital/analog conversion module 407 between the interfaces 405 and 408.

Each of the elements 400 and 402 to 408 taken in isolation is well known to those skilled in the art. These common elements are not therefore described here.

It will be noted that the word “register” used throughout the description designates, in each of the memories mentioned, a low-capacity memory zone (with some bits) as well as a high-capacity memory zone (enabling the storage of an entire program or the totality of the conversion and/or configuration program).

The random-access memory 402 comprises especially:
the working program of the processor 400, loaded when the converter 108a is powered on;
the configurations of each of the peripherals (analog devices) connected to the converter 108a, especially the configuration (“ConfigROM”) of the video-cassette recorder 109 in the example of FIG. 1; and
data, variables and intermediate processing results.

Thus, the converter 108a can manage several analog devices and convert the IEEE 1394 messages that are addressed to it with its own IEEE 1394 address. Upon the reception of a message containing a command intended for an analog device, the converter 108a implements means enabling it to associate the received command with a corresponding peripheral configuration.

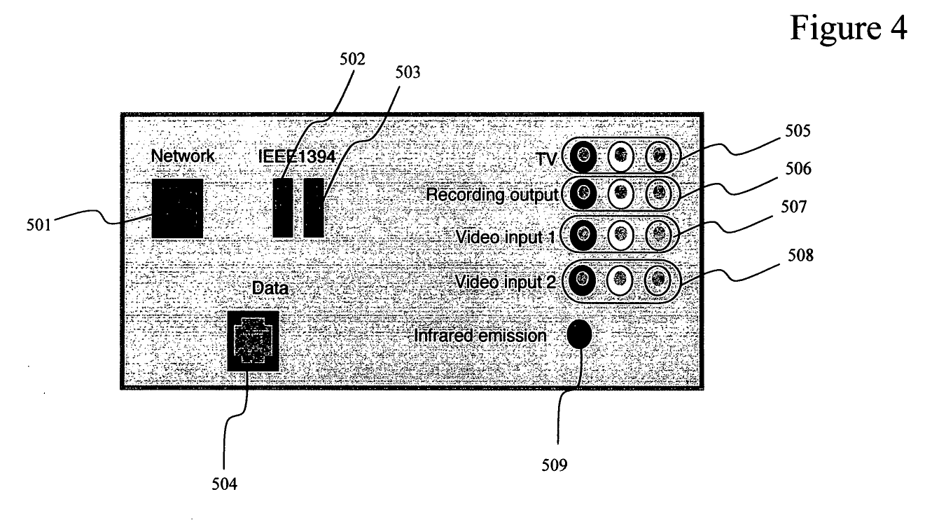

FIG. 4 shows a particular embodiment of a panel of connectors located on the rear face of a multimedia interface device (node) appearing in FIG. 1. This panel comprises:
a connector 501 for the backbone network which receives, for example, a link referenced 101a, 101b, 101c or told in FIG. 1;
two connectors 502, 503 for IEEE 1394 serial buses, each receiving for example a link referenced 105a or 105b in FIG. 1;
an RJ 45 type Ethernet connector 504 that receives an Ethernet cable (not shown in FIG. 1);
a first composite set of audio/video output connectors 505 (video and OSD information) for a display device, for example one of the television sets 107a, 107b, 107c or 107d of FIG. 1);
a second composite set of audio/video output connectors 506 (video only) for a recording device (for example the video-cassette recorder 110 of FIG. 1);
two composite sets of audio/video input connectors 507, 508 for source video devices (not shown in FIG. 1);
an infrared emission connector 509, to control an analog device from a remote node.

It will be noted that the first composite set of audio/video output connectors 505 is distinguished from the second one 506 by the fact that it also conveys OSD (on-screen display) information. This OSD information would be managed in the context of a user graphic interface. It is displayed before the video, on a display device, when the user handles the remote control unit associated with the node with which this display device is connected. By contrast, this OSD does not have to be recorded by a recording device which would be connected to the same node as the above-mentioned display device. This is why two composite sets of audio/video output connectors 505 and 506 are necessary.

For the sake of simplification, in the rest of the description, the generic terms “source device”, “recording device” and “display device” are replaced by the terms “source”, “recorder” and “television sets” respectively.

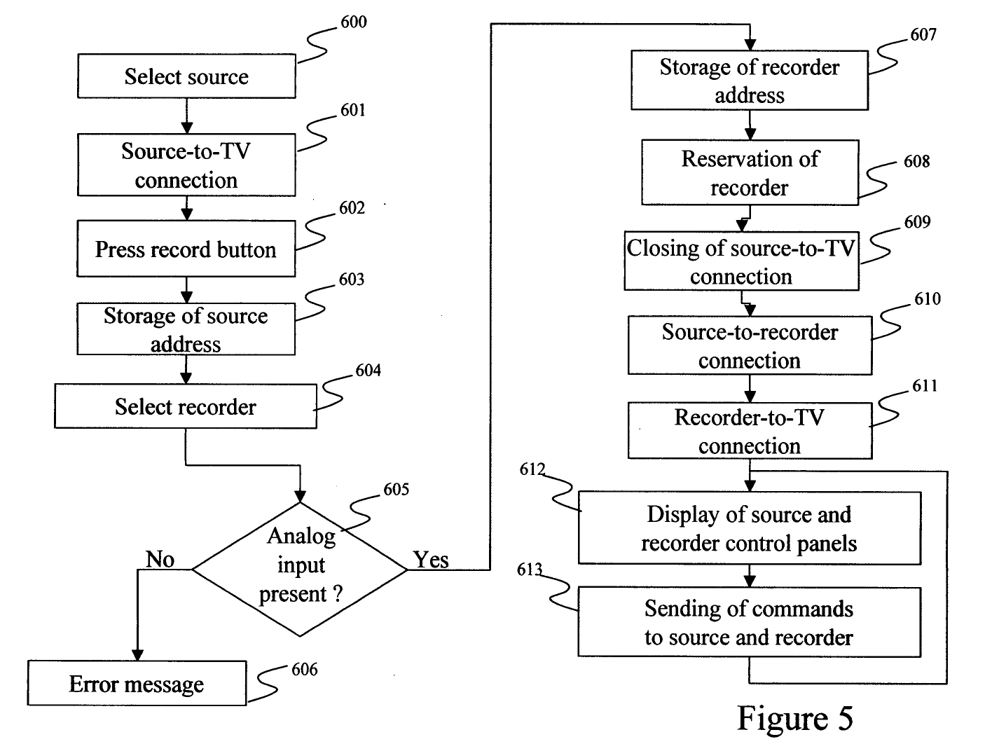

Referring now to the flow chart of FIG. 5, a description shall be given of a first particular embodiment of the method according to the invention.

It is implemented for example by each node of the network, a permanent memory of which stores one or more programs implementing the invention, as well as data processed according to the invention. It may be recalled (see description of FIG. 2 here above) that, when the node is powered on, the microcontroller 338 will load the program contained in the flash memory 305 into the RAM 306 and execute the code associated with this program.

First of all (in the step 600), the user selects a source in using a user interface. Typically, in the context of this user interface, the user has a remote control unit to send commands to a node of the network that is before him. This node is called a “local node” hereinafter in the description, the other nodes being called “remote nodes”. Furthermore, also in the context of the user interface, the local node displays OSD information on a television set that is connected to it and is also before the user. The user can thus make choices according to information that he views on this television set.

Then (step 601), a preliminary viewing connection is set up between the selected source and the television sets before which the user is placed.

Then, if the user wishes to record the audio/video stream of the source that he is watching on the television set before him, he launches a recording procedure by using the above-mentioned user interface (step 602). To this end he presses, for example, a “record button” on the above-mentioned remote control unit.

Then (step 603) the address of the source is stored. This address is used subsequently to enable the user to control the source, as described in detail here below.

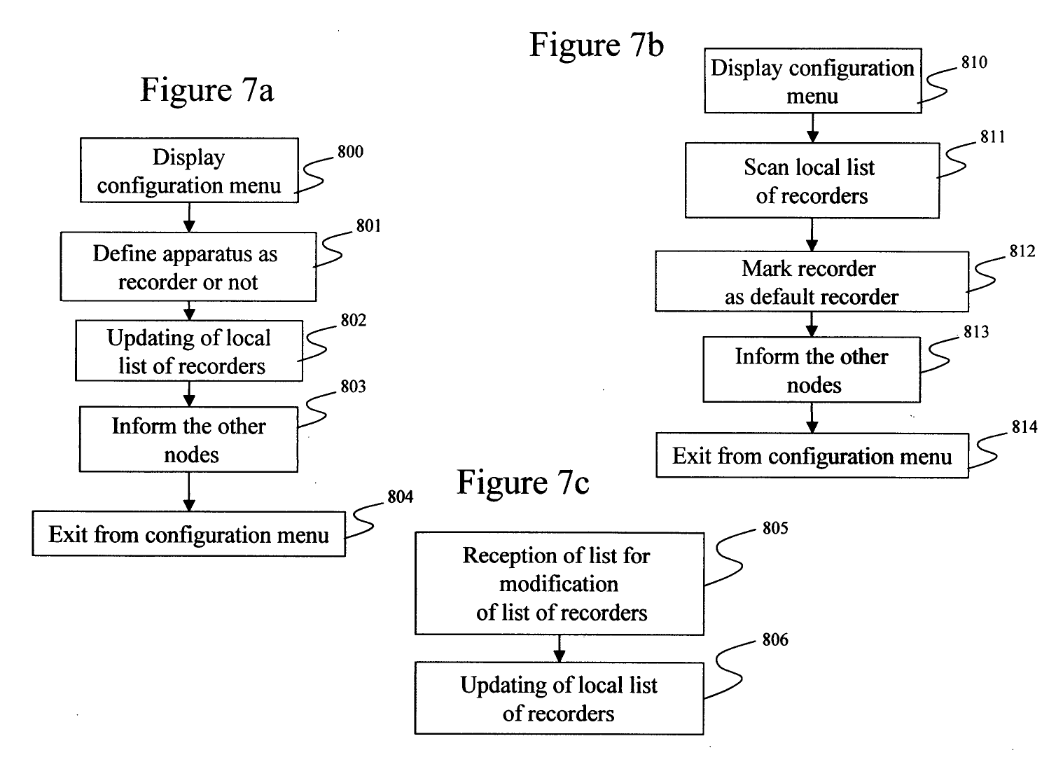

In the step 604, the user selects a recorder in using the above-mentioned user interface. According to one variant, a default recorder for the network is selected automatically (see the description of FIG. 7b here below).

A test is performed to ascertain that an analog input is truly present at the node to which the recorder (step 605) is connected. If this is not the case, there can be no recorder connected to this node. Hence an error message is displayed and the processing stops (step 606).

If not, the address of the recorder too is stored (step 607). Its subsequent use in order to enable the user to control the recorder is also described in detail here below.

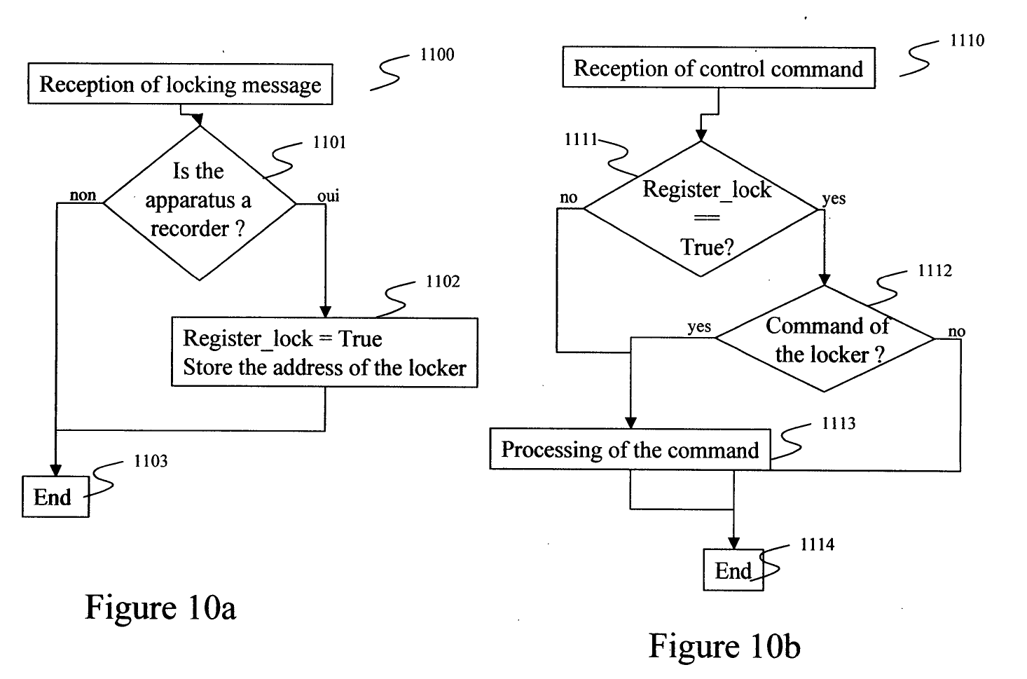

In the step 608, the recorder is locked, i.e. reserved. As described in detail here below with reference to FIG. 10a, this means that a locking message is sent by the local node to the recorder (or to the converter through which it is connected to the network), so that the network modifies one of its registers in memory, so as to indicate that only the local node (which has sent the locking message to it) can control it. In other words, after it has been locked, the recording device execute only commands sent by the local node with which the user has interacted, through the user interface, to request the execution of the step for setting up the recording connection.

Then, the preliminary viewing connection between the selected source and the television set before which the user is placed is eliminated (step 609) and replaced by:
a recording connection set up between the selected source and recorder (step 6010), and
a viewing connection set up between the recorder and the television set before which the user is placed (step 611).

Thus, on the television set, the user can see the audio/video stream being recorded by the recorder.

In order to enable the control of the source and the recorder by the user, the above-mentioned user interface is complemented by two control panels (or screens) which are displayed on the television set, one for the source and the other for the recorder (step 612).

Thus, through his remote control unit by which he can interact with the two control panels, the user can send commands to the source and to the recorder (step 613). The addresses of these panels will have been stored beforehand for this purpose.

The second control panel especially enables the user to request the sending of a record command to the recorder device.

The patent FR 2 828 355 may be referred to for further details on the use of infrared commands to control remote equipment within a communications network.

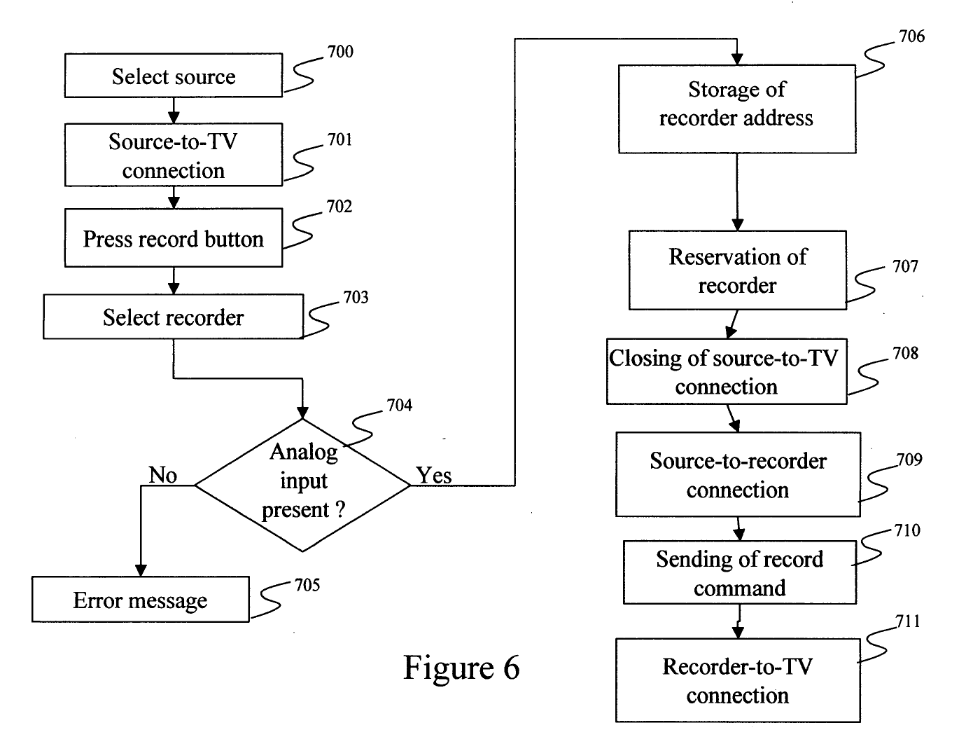

Referring to the flow chart of FIG. 6, a second particular embodiment of the method of the invention is now presented.

The steps 700 to 709 and 711 of the second embodiment are respectively identical to the steps 600 to 602, 604 to 611 of the first embodiment.

It will be noted that, in the second embodiment, there is no step for the storage of the address of the source (step 603 of the first embodiment).

Furthermore, the second embodiment comprises an additional step 710, between the steps 709 and 711. In this additional step 710, the local node automatically sends a record command to the recording device, so that it starts recording immediately upon reception of this record command. The address of the recording device has been stored beforehand for this purpose.

FIG. 7a is a flow chart of an algorithm according to the invention for the addition/elimination of an analog device acting as a recording device connected to the network. It is implemented, for the example, for each node of the network.

First of all (step 800), the user selects a configuration menu in using the user interface of the node located in front of him (local node).

Then (step 801), it defines the analog device concerned as a being a recorder (addition) or not a recorder (elimination).

Then, the local node updates its (local) list of recorders connected to the network (step 802). Furthermore, it sends a message of modification to the other nodes of the network, containing the identification number and the address of the recorder concerned (step 803). Thus, the other nodes are informed of the fact that a recorder has been added to or eliminated from the list of recorders of the network.

Finally (step 804), the user comes out of the configuration menu.

FIG. 7b is a flow chart of an algorithm according to the invention for the definition of a recording device associated by default with the network. It is implemented, for example, by each node of the network.

First of all (step 810), the user selects a configuration menu in using the user interface of the node before him (local node).

Then he scans the local list (namely the list managed by the local node) of the recorders connected to the network (step 811) and marks the recorder he has chosen as being the new default recorder (step 812). The mark associated with the preceding default recorder is eliminated.

In the step 813, the local node sends a message of modification to the other nodes of the network, containing the identification number and the address of the new default recorder.

Finally (step 814), the user exits from the configuration menu.

FIG. 7c is a flow chart of an algorithm according to the invention for the processing, by each node, of a message for updating a list of recording devices connected to the network. It is implemented for example by each node of the network.

After reception of such a message (step 805), each node updates its list of recorders connected to the network, as a function of the information contained in the message (step 806). This updating consists of the addition or elimination of a recorder (in the case of the message of the step 803 of FIG. 7a), or of a change of the default recorder (in the case of the step 813 of FIG. 7b). In this case, it is necessary to mark the new default recorder, and eliminate the marking associated with the previous default recorder.

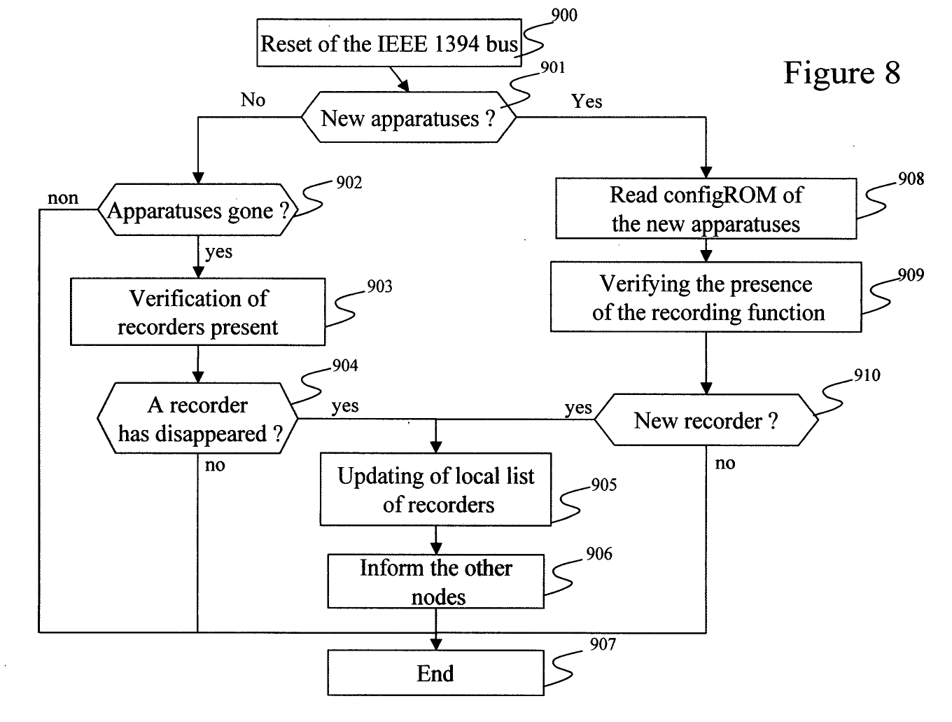

FIG. 8 is a flow chart of an algorithm according to the invention for the management of a list of recording devices connected to the network, after a digital device has been connected to or disconnected from the network. It is for example implemented by each node of the network.

The connection (or plugging) or disconnection (or unplugging) of a device to or from an IEEE 1394 bus connected to a given node, hereinafter called a local node, generates a resetting of this bus. In the step 900, the local node detects such a reset of the bus.

In the step 901, the local node sees whether a new device has been connected to (i.e. plugged into) the bus.

If this is the case the local node reads the contents of a configuration register of each new device (step 908) and the information relative to the recording function of this device is extracted (step 909). In the step 910, the local node sees whether each new device is a recorder. If it is a recorder, the local node adds it to its local list of recorders connected to the network (step 905) and sends a modification message to the other nodes of the network (containing the identification number and the address of the concerned recorder (step 906), and the process is terminated (step 907). If this is not a recorder, the process is terminated (step 907).

If the answer at the step 902 is negative (i.e. if no new device has been connected to the bus), the local node sees whether a device has been disconnected or unplugged from the bus (step 902). If there has been no device disconnected, the process is terminated (step 907). If a device has been disconnected, the local node verifies that the recorders previously connected to the local IEEE 1394 bus are still connected (steps 903 and 904). If no recorder of the local bus has been disconnected, the processes terminated (step 907). If a recorder of the local bus has been disconnected, the local node room removes it from its local list of recorders connected to the network (step 905) and sends a modification message to the other nodes of the network (containing the identification number and the address of the recorder concerned) (step 906), and the process is terminated (step 907).

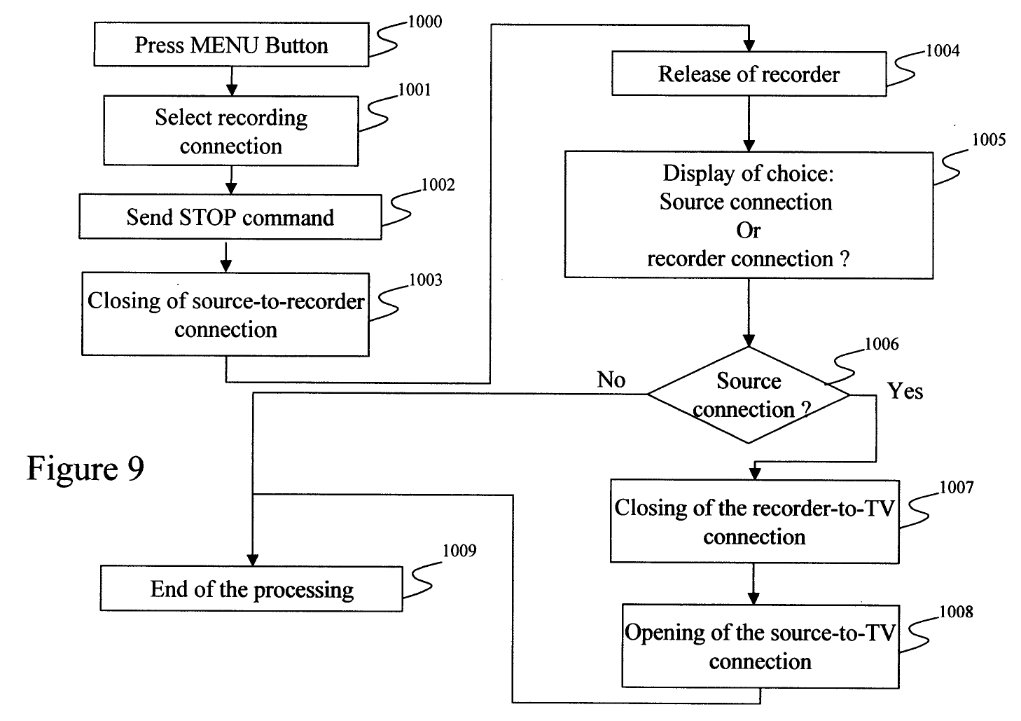

FIG. 9 is a flow chart of an algorithm according to the invention for stopping a recording session. It is implemented for example by each node of the network.

When the user wishes to interrupt a recording session, he presses a “MENU” button on the above-mentioned remote control unit (step 1000). Then, he selects the recording connection that he wishes to interrupt (step 1001) and a stop command is sent to the recorder (step 1002). The recording connection between the source and the recorder is then eliminated (step 1003), and the recorder is unlocked (i.e. released) in the step 1004. The connection between the recorder and the television set can be maintained so as to enable the user to re-read the data recorded or process it as a function of the capacities of the recorder, or this connection can be replaced by a connection between the source and the television set to continue to the viewing of the source without recording. A screen proposing this choice is therefore displayed (step 1005) and the node sees whether the connection has to be modified (step 1006). If this is so, the connection between the recorder and the television is closed (step 1007), then a connection between the source and the television set is set up (step 1008) and the algorithm is terminated (step 1009). If not, the algorithm is terminated directly (step 1009).

FIG. 10a is a flow chart of an algorithm according to the invention for processing a message for locking a recording device (see step 608 of FIG. 5). It is implemented for example by each node of the network.

In the step 1100, the node (here below called a remote node) receives a locking message sent by the local node with which the user has interacted, via the user interface.

Then the remote node sees whether the device to be locked is a recorder or not (step 1101). If it is not a recorder, the process is terminated (step 1103). Else, a register (hereinafter called a “register-lock”) passes into the “true” state and the address of the “locking unit” (the local node that has sent the locking message) is stored (it is given by the message) (step 1102). The process is then terminated (step 1103).

FIG. 10b is a flow chart of an algorithm according to the invention for processing a message containing a command to control a recorder, this message being sent during one of the steps of the method illustrated in FIG. 5. It is for example implemented by each node of the network.

In the state 1110, the node (hereinafter called a remote node) receives a message containing a control command, sent by the local node with which the user has interacted through the user interface.

Then, the remote node detects whether the “register_lock” is in the “true” state, namely if the recorder is locked (step 1111). If not, the command is executed by the recorder (step 1113) and the process is terminated (step 1114). If not, the remote node sees whether the message is sent by the “the locking unit” as defined in the step 1102 of FIG. 10a (step 1112). If the message is not sent by the “locking unit”, the process is terminated (step 1114). If the message is sent by the “locking unit”, the command is executed by the recorder (step 1113) and the process is terminated (step 1114).

What is claimed is:

1. A method for the management of the recording of an audio/video stream within a communications network, said method comprising a step for setting up a first recording connection between a source device and a recording device connected to said communications network,
wherein said step for setting up the first recording connection is followed by a step for setting up a second viewing connection between the recording device and a display device also connected to said network, so that a user can observe an audio/video image corresponding to the audio/video stream, on said display device, while the stream is being recorded by the recording device.

2. A method according to claim 1, wherein the execution at the user's request of said step for setting up the first recording connection leads to the automatic execution, by the network, of said step for setting up the second viewing connection.

3. A method according to claim 1, the communications network comprising a backbone network itself comprising a plurality of nodes to which a plurality of devices and especially said source device, said recording device and said display device are connected, directly or via sub-networks, wherein said method is implemented in said nodes.

4. A method according to claim 3, wherein said display device is selected by default, as a display device associated and connected with the node with which said user interacts, via a user interface, to request the execution of said step for setting up the first recording connection.

5. A method according to claim 1, wherein the step for setting up the first recording connection is preceded by the following successive steps:
the selection of the source device, by default or by the user, through a user interface;
the setting up of a preliminary viewing connection between the source device and the display device;
the sending by the user, through said user interface, of a recording request;
the selection of the recording device, by default or by the user, through said user interface;
the elimination of said preliminary display device.

6. A method according to claim 1, wherein the step for setting up the first recording connection is preceded by a step for the storage of an address of the source device, and wherein the step for setting up the second viewing connection between the recording device and the display device is followed by a step for the management of a user interface comprising a first control panel displayed on the display device and enabling the user to control the source device by the sending of commands, via the communications network, to the previously stored address of the source device.

7. A method according to claim 1, wherein the step for setting up the first recording connection is preceded by a step for the storage of an address of the recording device, and the step for setting up the second display connection, between the recording device and the display device, is followed by a step for the management of a user interface comprising a second control panel displayed on the display device and enabling the user to control the recording device by the sending of commands, through the communications network, to the previously stored address of the recording device.

8. A method according to claim 7, wherein the second control panel enables the user to request the sending of a recording command to the recording device.

9. A method according to claim 1, wherein the step for setting up the first recording connection is followed by a step for the automatic sending of a recording command to the recording device, so that the recording device starts recording immediately upon reception of said recording command,
and wherein, the step for setting up the second viewing connection is preceded by said step for sending a recording command.

10. A method according to claim 1, the communications network comprising a backbone network itself comprising a plurality of nodes to which a plurality of devices, and especially said source device, said recording device and said display device are connected, directly or via sub-networks,
the method of the invention furthermore comprising a step for locking the recording device so that it executes only commands sent by the node with which the user interacts, via a user interface, to request the execution of said step for setting up the first recording connection.

11. A method according to claim 1, furthermore comprising the following steps:
the sending of a request to stop said recording; and
the elimination of said first recording connection, between the source device and the recording device.

12. A method according to claim 11 wherein, after the elimination of said first recording connection, said second viewing connection, between the recording device and the display device is kept.

13. A method according to claim 11, wherein, after the elimination of said first recording connection, said second viewing connection, between the recording device and the display device, is replaced by a connection between the source device and the display device.

14. A method according to claim 11, wherein the step for eliminating the first recording connection is followed by a step for unlocking the recording device.

15. A computer program product, comprising program code instructions for the execution of the steps of the method according to one of the claims 1 to 14, when said program is executed on a computer.

16. A device to manage the recording of an audio/video stream within a communications network, said device comprising means for setting up a first recording connection between a source device and a recording device connected to said communications network,
said device furthermore comprising means for setting up a second viewing connection between the recording device and a display device also connected to said network, so that a user can observe an audio/video image corresponding to the audio/video the audio/video stream, on said display device, while the stream is being recorded by the recording device.

17. Device according to claim 16, furthermore comprising the following means, activated before said means for setting up the first recording connection:
means for the selection of the source device, by default or by the user through a user interface;
means for setting up a preliminary viewing connection between the source device and the display device;
means for the reception of a recording request sent by the user, by means of said user interface;
means for the selection of the recording device, by default or by the user through said user interface;
means for the elimination of said preliminary viewing connection.

18. A device according to claim 16, furthermore comprising:
means to receive a request to stop said recording;
means to receive said first recording connection, between the source device and the recording device;
means to maintain said second viewing connection, between the recording device and the display device, after the elimination of said first recording connection.

19. A device according to claim 16, furthermore comprising:
means to receive a request to stop said recording;
means to eliminate said first recording connection, between the source device and the recording device;
means to replace said second viewing connection, between the recording device and the display device, by a connection between the source device and the display device, after the elimination of said first recording connection.
